(19) United States
(12) Patent Application Publication
(10) Pub. No.: US 2019/0291116 A1
(43) Pub. Date: Sep. 26, 2019

(54) METHODS FOR LINEAR SAMPLE PROCESSING

(71) Applicant: NuGEN Technologies, Inc., Redwood City, CA (US)

(72) Inventor: Douglas A. Amorese, Los Altos, CA (US)

(21) Appl. No.: 16/355,155

(22) Filed: Mar. 15, 2019

Related U.S. Application Data
(60) Provisional application No. 62/645,405, filed on Mar. 20, 2018.

(51) Int. Cl. B01L 9/00; B01L 7/00

(52) U.S. Cl. CPC B01L 9/543; B01L 9/523; B01L 7/52; B01L 2400/04; B01L 2200/06; B01L 2300/0829; B01L 2300/0861; B01L 2200/025

(57) ABSTRACT

The invention provides methods for linear processing of multiple samples through a series of reactions. The methods allow parallel processing of multiple samples through a series of reactions. Systems for performing the methods are also provided.

### CROSS-REFERENCE TO RELATED APPLICATION

This application claims priority to U.S. Provisional Application Ser. No. 62/645,405, filed Mar. 20, 2018, the contents of which are incorporated by reference.

### FIELD OF THE INVENTION

The invention is related to methods and systems for processing samples through a series of reactions.

### BACKGROUND

Health professionals and research scientists spend years in the lab learning the fundamentals of practice. Those professionals are taught such principles as to always discard consumables such as pipette tips and reagent tubes, without reuse, to avoid sample contamination and to never return a sample to a collection tube after a purification. Those rules are applied when learning such basics as DNA extraction and polymerase chain reaction in college labs and are reinforced when performing original research. In fact, those fundamental sample handling principles underlie the operations of high-throughput liquid handling systems in automated environments.

Automation of molecular biology methods requires dispensing and delivery of small, precise volumes of many reagents. Methods of reagent delivery typically fall into two categories: complex robotic fluid handlers or microfluidic devices. Both typically distribute fluids from a central reservoir. Robotic fluid handlers have many moving parts, are expensive, challenging to maintain and large in size, but use off-the-shelf consumables such as pipette tips and reaction tubes. Hardware that controls microfluidic chips is simpler, less expensive and small but chips used for dispense and reactions can be expensive. Microfluidic chips are less flexible than liquid handling robots, are expensive, and difficult to customize. Due to set-up time and reagent overfill, robotic platforms are more practical with large numbers of samples. However, setting up and maintaining robotic fluid handlers to process hundreds of samples is time consuming and failure-prone at least in part due to the requirement of maintaining good laboratory practices, even when tedious, as hundreds or thousands of samples are processed through just as many steps.

### SUMMARY

The disclosure provides methods and systems for processing multiple samples in which each sample is serviced by its own dedicated aliquots of reagents, and tended by its own dedicated pipette. Each pipette services one sample and its dedicated reagents and thus cannot cross-contaminate samples. Because the pipette does not cross between samples or their reagents, the pipette tip does not need to be discarded and replaced between every step and some of the reaction vessels can be re-used. Even in automated, robotic embodiments of the disclosure, each pipette programmatically follows and works with only one sample, even as that sample progresses through sample preparation reactions, e.g., for library preparation. Using pre-plated reagents in which each sample gets its own row of library prep reagents, beads, enzymes, and buffers, the pipette follows the nucleic acid sample through the library preparation. The pipette tip gets washed when the nucleic acid gets washed. The pipette tip does not travel across rows to be used in other, unrelated samples. The pipette tip cannot contaminate the sample, and does not need to be changed during library preparation.

The multiple samples may be processed in parallel, in that each sample is progressed through a series of reactions by a dedicated pipette that only makes contact with that sample and aliquots of reagents that are also dedicated to that sample. In some embodiments, each sample and the reagents for a series of reactions are pre-filled in dedicated wells, such as along a row of a multiwell plate. The dedicated pipette draws from the sample well and the dedicated reagent wells, but the pipette does not ever cross over to another row of the plate, and thus does not enter any well associated with a different sample. By dedicating the reagent wells to one specific sample, and dedicating the pipette to that sample and its associated wells, the pipette does not cross-contaminate the samples.

Because the use of dedicated, sample-specific reagent wells and a sample-specific pipette avoids cross-contamination, liquid handling steps that are commonly used to prevent cross-contamination can be left out of the sample processing protocols. Because the reagent wells and pipettes may be provided as, e.g., multiwell plates and multi-channel pipettes, systems and methods of the disclosure are well-suited to automation. When the systems and methods are automated for high-throughput sample processing, the ability to omit previously required steps greatly decreases the complexity of machine setup, materials used, time, and materials lost to contamination.

The invention provides methods for linear processing of multiple samples through a series of reactions. The methods allow numerous reactions to be performed sequentially on a sample, such as a nucleic acid isolated from blood. According to the methods, a separate aliquot of components necessary to perform a reaction, such as enzymes or substrates, is provided for each sample. Because the methods avoid using shared sources of reaction components, consumable supplies, such as tubes and pippette tips, can be reused for many reactions on a sample without the risk of contaminating the sample with material from other samples. Consequently, the methods allow complex sequences of reactions to be performed on multiple samples in parallel using a minimal amount of supplies, reaction components, and sample material. The invention also provides systems for performing the methods.

The methods of the invention offer many advantages over prior methods for molecular analyses of samples. Analytical techniques commonly used in clinical or research settings involve extensive sequences of steps, such as extraction, purification, digestion, ligation, modification, amplification, and sequencing of nucleic acids. Some prior methods of multi-step processing rely on fluidic cartridges that must be custom-designed for a specific sequence of manipulations. In contrast, the methods of the invention can be performed on robotic liquid handlers, and the sequence of reactions can be easily adjusted by modifying the configuration of the reaction components. At the same time, the methods are simpler, faster, and cheaper than prior robotic methods of multi-step processing because they use fewer consumables and require fewer discard steps. Additionally, the methods provided herein use only the amounts of sample and reaction components necessary to perform each reaction. Consequently, the methods are advantageous for analysis of scarce sample material or for performing manipulations that require expensive reaction components.

In certain aspects, the disclosure provides a method of processing samples. The method includes providing a plurality of samples, providing a pipette and a plurality of reagents for each sample, and performing a series of transfers to, and/or reactions on, each sample using the pipette and reagents for that sample, without changing a pipette tip. Each pipette may have a pipette tip and the method may include using the pipette and the corresponding pipette tip for the series of reaction for each sample. Methods are useful where a sample includes nucleic acid and the series of reactions provides a library of DNA fragments that contain sequences corresponding to portions of the nucleic acid.

In some embodiments, the series of transfers are performed simultaneously and in parallel for each of the sample. The plurality of reagents for each sample may be provided in a row of wells along a multiwell plate. The pipette for each sample is provided as one member of a multichannel pipette. The performing step may include loading the multiwell plate and the multichannel pipette into a handling device, wherein the handling device operates to slide the multiwell plate to position predetermined columns of wells under the multichannel pipette, transfer, by means of the multichannel pipette, liquids among wells within rows of wells of the plate, and bring at least one column the multiwell plate into contact with a heating device to promote a reaction in wells of the at least one column. Optionally, each sample includes nucleic acid and performing the series of transfers results in a series of reactions that produces a library of DNA fragments, in which each fragment includes a sequence corresponding to a portion of the nucleic acid and an adapter.

Aspects of the disclosure provide a sample processing system that includes a multichannel pipette, a plurality of reagent wells, and a plurality of reagents replicated in subsets of the plurality of reagent wells. Preferably, the plurality of reagent wells are provided as at least one multiwell plate. The system may be operable to transfer reagents within each replicate of the plurality of reagents using, for that replicate, one pipette of the multichannel pipette. Each replicate of the plurality of reagents may be confined to one row of the multiwell plate. Optionally, the system is programmed to move the multichannel pipette to different columns of the multiwell plate while keeping individual pipette tips of the multichannel pipette within rows of the multiwell plate. In some embodiments, the system includes a handling device comprising at least one loading stage onto which the multiwell plate can be removably loaded, wherein the multichannel pipette is disposed by handling device to access wells of the multiwell plate when the multiwell plate is loaded onto the loading stage. The handling device may be operable to slide the multiwell plate to position predetermined columns of wells under the multichannel pipette, transfer, by means of the multichannel pipette, liquids among wells within rows of wells of the plate, and bring at least one column the multiwell plate into contact with a heating device to promote a reaction in wells of the at least one column.

In certain embodiments, each replicate of the plurality of reagents comprises beads for capturing and isolating nucleic acid fragments; amplification enzymes; sequencing adaptors; and ligase. The plurality of reagent wells may be provided as at least one multiwell plate and the system include a plurality of sample distributed across a column of wells. Each sample may include nucleic acid and the system may be operable to produce a library of DNA fragments, in which each fragment comprises a sequence corresponding to a portion of the nucleic acid and an adapter.

In an aspect, the invention provides methods of performing a reaction. The methods include transferring particles bound to a reagent to a first reservoir containing a first liquid using a transfer receptacle, which allows the reagent to be released from the particles; transferring the reagent from the first reservoir to a second reservoir using the transfer receptacle; transferring a second liquid containing a reactant from a third reservoir to the second reservoir using the transfer receptacle, which allows the reagent and the reactant to react; and transferring particles from a fourth reservoir to the second reservoir using the transfer receptacle, which allows the reagent to bind to the particles. Preferably, the transferring steps are performed in sequence. Preferably, the transfer receptacle is not washed between transferring steps.

The reservoirs may be named according to their functions within the method. For example, the first reservoir may be called an elution buffer storage reservoir because it may contain a liquid buffer that promotes release of the reagent from the particles. The second reservoir may be called the reaction reservoir because it is the site of the reaction between the reagent and one or more reactants. The third reservoir may be called the reactant reservoir because it contains a liquid containing a reactant. The fourth reservoir may be called the particle storage reservoir because it may contain particles that are added to reaction reservoir.

The transfer receptacle may be any receptacle suitable for the transfer of liquid. The transfer receptacle may be a pipette tip, pipette, tubing, vessel, tube, or the like.

The second reservoir may contain a substance that prevents evaporation of liquids from the reservoir. The second reservoir may contain an organic liquid that is immiscible with water. Preferably, the organic liquid is less dense than water. The organic liquid may be an oil, such as mineral oil, corn oil, or vegetable oil. Preferably, the organic liquid is mineral oil. The organic liquid may be an alkane, ketone, benzene, toluene, tetrahydrofuran, triethyl amine, or xylene.

The reagent may be a biological macromolecule. The reagent may be a nucleic acid, protein, lipid, carbohydrate, or any combination thereof. Preferably, the reagent is a nucleic acid, such as DNA or RNA.

The first liquid may have a composition that promotes release of the reagent from the particles. The first liquid may be an elution buffer. The composition may contain an agent that alters pH, salt concentration, or the presence of chaotropic agents. The composition may be free of an agent that promotes binding of the reagent to the particles.

The reactant may be any agent that interacts with the reagent to permit a chemical reaction to occur. The reactant may be a substrate, enzyme, catalyst, or cofactor. For example, the reactant may be an enzyme, such as an endonuclease, exonuclease, gyrase, kinase, ligase, methyltransferase, nickase, phosphatase, polymerase, recombinase, sulfurylase, thermostable polymerase, or uracil-DNA glycosylase. The reactant may be a metal, such as calcium, copper, iron, magnesium, or manganese, molybdenum, nickel, or zinc. The reactant may be a nucleotide, such as a deoxyribonucleotide triphosphate or a ribonucleotide triphosphate.

The second liquid may contain multiple reactants.

The particles may contain any suitable material for reversible binding of the reagent. For example, the particles may contain silica or glass to facilitate binding of nucleic acid reagents. The particles may contain magnetic material to facilitate separate of the particles from liquid contents in a reservoir.

The reservoirs may be disposed within structures, such as plates. The reservoirs may be disposed within a single structure or within multiple structures. Preferably, the first and third reservoirs are disposed within a first structure, and the second and fourth reservoirs are disposed within a second structure.

The methods may include heating or cooling the second reservoir to facilitate the reaction. The methods may include maintaining the second reservoir at the heated or cooled temperature for a period of time. The second reservoir may be heated or cooled to any temperature suitable for performing the reaction. Preferably, the second reservoir is heated or cooled following transfer of the second liquid containing the reactant to the second reservoir.

The methods may include returning the second reservoir to the temperature of the second reservoir prior to heating or cooling the second reservoir.

The methods may include applying a magnetic field to a reservoir. The magnetic field may be used to retain particles, e.g., magnetic particles or paramagnetic particles, in a reservoir. The magnetic field may be applied prior to a transfer step, during a transfer step, or both. The magnetic field may be applied to the first reservoir.

The methods may include performing a series of reactions. For example, the steps described above may be performed in sequence, and the sequence may be repeated by replacing the first reservoir with a fifth reservoir that contains a liquid having a composition that promotes release of the reagent from the particles; replacing the third reservoir with a sixth reservoir that contains a liquid that contains a reactant; and reusing the second and fourth reservoirs. Thus, the second iteration of the sequence requires a new elution buffer storage reservoir and a new reactant reservoir, but the reaction reservoir and the particle storage reservoir are reused. The first and fifth reservoirs, i.e., the elution buffer storage reservoirs, may contain the same liquid, or they may contain different liquids. Preferably, the third and sixth reservoirs, i.e., the reactant reservoirs, contain liquids having at least one reactant that differs between them. The same transfer receptacle is used for the first and second sequence of steps to perform the first and second reactions. Preferably, the transfer receptacle is not washed during the first or second sequence of steps.

The methods may include performing any number of reactions by repeating the sequence steps. For example, the methods may include performing 2, 3, 4, 5, 6, 7, 8, 9, 10 or more reactions in sequence. Preferably, each iteration of the sequence includes its own elution buffer storage reservoir and its own reactant reservoir. Preferably, each iteration of the sequence uses the same reaction reservoir and particle storage reservoir. The same transfer receptacle may be used for each iteration of the sequence. Preferably, the transfer receptacle is not washed during the iterations of the sequence.

In another aspect, the invention provides methods of performing a reaction. The methods include transferring particles bound to a reagent to a first reservoir containing a first liquid using a transfer receptacle, which allows the reagent to be released from the particles; transferring the reagent from the first reservoir to a second reservoir using the transfer receptacle; transferring a second liquid containing a reactant from a third reservoir to the second reservoir using the transfer receptacle, which allows the reagent and the reactant to react; transferring a third liquid from a fourth reservoir to the first reservoir, which allows the particles to be resuspended in the third liquid; and transferring the particles from the first reservoir to the second reservoir, which allows the reagent to bind to the particles. Preferably, the transferring steps are performed in sequence. Preferably, the transfer receptacle is not washed between transferring steps.

The methods may include one or more steps for washing the particles. The washing may include transferring a liquid to the first reservoir, which allows the particles to be resuspended in the liquid. The washing may include removing the liquid from the first reservoir while the particles remain in the first reservoir. The washing may include applying a magnetic field to the first reservoir to retain the particles therein. The washing may occur after transferring the reagent from the first reservoir to the second reservoir but prior to transferring the third liquid from the fourth reservoir to the first reservoir. The methods may include performing any of the washing-related steps multiple times.

The methods may include performing a series of reactions. For example, the steps described above may be performed in sequence, and the sequence may be repeated by replacing the first reservoir with a fifth reservoir that contains a liquid having a composition that promotes release of the reagent from the particles; replacing the third reservoir with a sixth reservoir that contains a liquid that contains a reactant; and reusing the second and fourth reservoirs. Thus, the second iteration of the sequence requires a new elution buffer storage reservoir and a new reactant reservoir, but the reaction reservoir and the particle storage reservoir are reused. The first and fifth reservoirs, i.e., the elution buffer storage reservoirs, may contain the same liquid, or they may contain different liquids. Preferably, the third and sixth reservoirs, i.e., the reactant reservoirs, contain liquids having at least one reactant that differs between them. The same transfer receptacle is used for the first and second sequence of steps to perform the first and second reactions. Preferably, the transfer receptacle is not washed during the first or second sequence of steps.

In an aspect, the invention provides a reaction system that includes a transfer receptacle, a first reservoir containing a first liquid, a second reservoir, a third reservoir containing a second liquid containing a reactant, and a fourth reservoir containing particles. The system is configured to allow a reagent to react with the reactant by performing the following steps in sequence: transferring particles bound to the reagent to the first reservoir using the transfer receptacle, which allows the particles to release the reagent; transferring the first liquid and the reagent from the first reservoir to the second reservoir using the transfer receptacle; transferring the second liquid from the third reservoir to the second reservoir using the transfer receptacle, which allows the reagent and the reactant to react; and transferring the particles from the fourth reservoir to the second reservoir using the transfer receptacle, which allows the reagent to bind to the particles.

In an aspect, the invention provides a reaction system that includes a transfer receptacle, a first reservoir containing a first liquid, a second reservoir, a third reservoir containing a second liquid containing a reactant, and a fourth reservoir containing a third liquid. The system is configured to allow a reagent to react with the reactant by performing the following steps in sequence: transferring particles bound to the reagent to the first reservoir using the transfer receptacle, which allows the particles to release the reagent; transferring the reagent from the first reservoir to the second reservoir using the transfer receptacle; transferring the second liquid from the third reservoir to the second reservoir using the transfer receptacle, which allows the reagent and the reactant to react; transferring the third liquid from the fourth reservoir to the second reservoir using the transfer receptacle, which allows the particles to be resuspended in the third liquid; and transferring the particles from the first reservoir into the second reservoir, which allows the reagent to bind to the particles.

As described above in relation to methods of the invention, the reservoirs may be disposed within structures, such as plates. The reservoirs may be disposed within a single structure or within multiple structures. Preferably, the first and third reservoirs are disposed within a first structure, and the second and fourth reservoirs are disposed within a second structure. The first plate and second plate may be displaced from each other along a Z-axis. The first plate and second plate may be slideable relative to each other along an X-axis.

The second reservoir may include a temperature-control mechanism, such as a heating and/or cooling mechanism.

Other features described above in relation to methods of the invention apply to systems of the invention.

### BRIEF DESCRIPTION OF THE DRAWINGS

FIG. 1 diagrams a method of the disclosure.

FIG. 2 shows a reaction plate.

FIG. 3 is a side view of the reaction plate.

FIG. 4 shows a reagent plate.

FIG. 5 is a side view of the reagent plate.

FIG. 6 shows a system of the invention.

FIG. 7 is a schematic of a method according to an embodiment of the invention.

FIG. 8 is a schematic of a method according to an embodiment of the invention.

FIG. 9 is a schematic of a storage plate according to an embodiment of the invention.

FIG. 10 is a schematic of a reaction plate according to an embodiment of the invention.

FIG. 11 is a schematic of a system according to an embodiment of the invention.

### DETAILED DESCRIPTION

The invention provides systems and methods for processing multiple samples in parallel through a sequence of steps, such as biochemical reactions. The methods entail processing samples linearly using a dedicated reaction reservoir, such as a tube or well of a plate, and transfer receptacle, such as a pipette or pipette tip, for each sample. Consequently, the methods are simple and inexpensive to perform and can be readily adapted to accommodate changes in the desired series of steps. Similarly, the systems of the invention are simpler and cheaper than prior systems that rely on robotic liquid handler and more flexible than microfluidic chip-based systems.

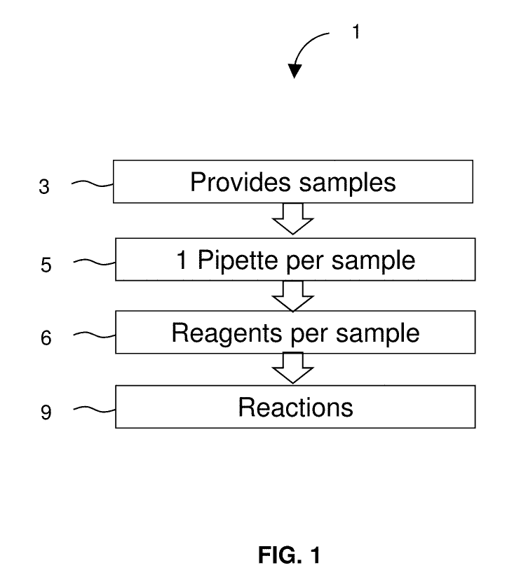

FIG. 1 diagrams a method 1 of processing samples. The method 1 includes providing 3 a plurality of samples; providing 5 a pipette and providing 6 a plurality of reagents for each sample; and performing 9 a series of reactions on each sample using the pipette and reagents for that sample. Each pipette has a pipette tip and the method includes using the pipette and the pipette tip for the series of reaction for each sample. Each sample includes nucleic acid. The series of reactions provides a library of DNA fragments that contain sequences corresponding to portions of the nucleic acid. The series of reactions are performed simultaneously and in parallel for each of the sample. The disclosure provides a flexible, simple, low cost system capable of processing a small number of samples through multiple steps with minimal set-up time. By linearly processing a sample using a dedicated pipette and reaction tubes for each sample, a system can have the flexibility of a robotic liquid handler but a simple, low-cost design. A preconfigured plate of reagents allows multiple reagents to be delivered and complex methods to be executed. This configuration allows a number of samples to be processed simultaneously. A simple hardware devise transfers reagents to a reaction vessel situated below the pipette tip.

By linearly processing samples, each sample only comes in contact with a single pipette tip and a fixed set of reaction tubes. This pipette tip is used multiple times instead of being used once and discarded. Similarly, reaction tubes are reused. Here, however, it is optimal to employ 2 (or more) tubes. One tube contains magnetic beads for purification/buffer exchange steps, while the second is free of beads and their potential to interfere with reaction components and enzymes. Maintaining linearity simplifies and reduces the cost of the automation used in the transfer and dispense.

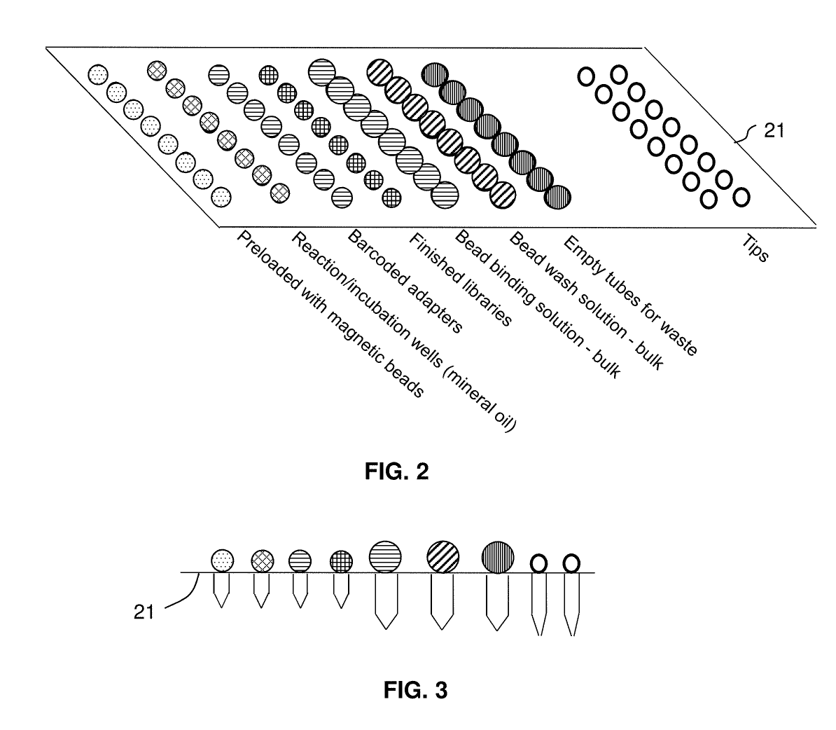

FIG. 2 shows a multiwell sample/reaction plate 21. The reaction plate 21 preferably has at least three tubes; sample input, reaction, and finished library. The sample input tube is prefilled with magnet beads for concentration/purification steps, the reaction tube is prefilled with mineral oil for evaporation control and the finished library tube that has not been exposed to any reactants. The oil in the reaction tube, in addition to controlling evaporation, is used to better allow the pipette to withdraw the aqueous solution without sucking up air bubbles, which can be difficult to get rid of. Rather than leaving a small amount of reaction behind or sucking up a couple of microliters of air, the pipette draws up a small volume of oil. This plate also contains bulk solutions for bead capture and washing as well as a waste container. Further, this plate has nominally two sets of pipette tips; set 1 is used in all reagent delivery, mixing and transfer to the bead containing tube, set 2 is used to deliver the final product from the beads following the last wash step to the finished library tube.

FIG. 3 is a side view of the plate 21, to aid in understanding progression through the reagents.

In certain embodiments, there are separate plates for the sample/reaction plate 21 and for aliquots of reagents, such that the method uses a reagent plate and the sample/reaction plate 21.

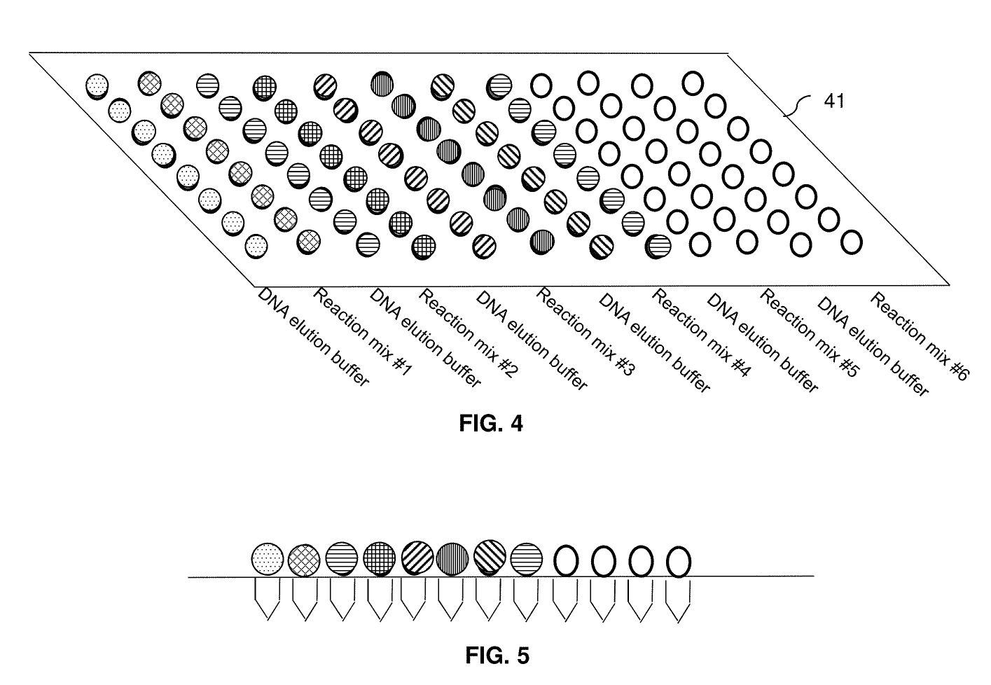

FIG. 4 shows a reagent plate 41 according to certain embodiments.

FIG. 5 is a side view of the reagent plate 41. The reagent plate 41 preferably contains prefilled reagents and elution buffers. Each well contains only the amount of reagent necessary for a single reaction. These reagents are laid out in a series where each is used sequentially and only once. By not sharing reagents between samples and by not returning to the same well for a second withdrawal, any residual reagent or nucleic acid left on the tip does not cross contaminate or negatively impact the next reaction.

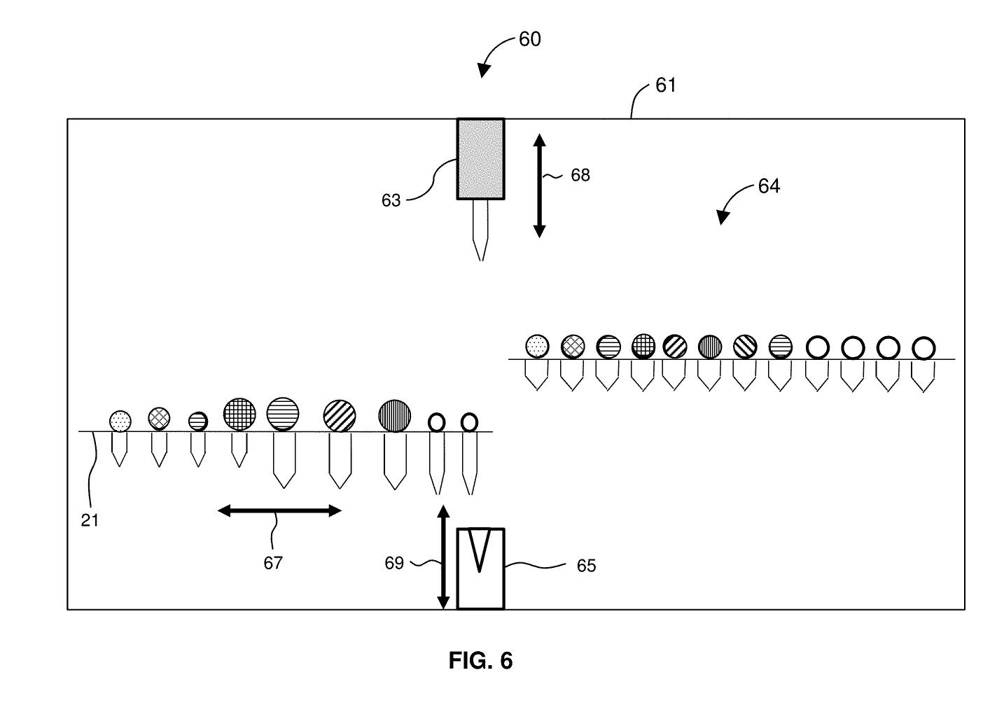

FIG. 6 shows a sample processing system 60. The system includes at least one multichannel pipette 63; a plurality of reagent wells 62; and a plurality of reagents 64 replicated in subsets of the plurality of reagent wells 62.

The depicted embodiment makes use of a sample/reaction plate 21 and a reagent plate 41, although that plurality of wells 62 could be combined onto a single plate or distributed over a larger number of plates.

FIG. 6 illustrates loading the sample/reaction plate 21 and the reagent plate 41 onto a handling device 61. The handling device 61 includes at least one loading stage 67 and optionally a second loading stage. The handling device 61 may optionally include a pipette actuator 68 operable to introduce the pipette 63 into wells. The handling device 61 may optionally include a heating element 65, e.g., optionally with its own lifting actuator 69.

FIG. 6 illustrates loading the sample/reaction plate 21 and the reagent plate 41 onto a handling device 61. The handling device 61 includes at least one loading stage 67 and optionally a second loading stage. The handling device 61 may optionally include a pipette actuator 68 operable to introduce the pipette 63 into wells. The handling device 61 may optionally include a heating element 65, e.g., optionally with its own lifting actuator 69. The system is operable to carry a multichannel pipette via a handling device. The handling device operates to slide the multiwell plate to position predetermined columns of wells under the multichannel pipette, transfer, by means of the multichannel pipette, liquids among wells within rows of wells of the plate, and bring at least one column the multiwell plate into contact with a heating device to promote a reaction in wells of the at least one column. In certain embodiments, the system maintains two plates that travel one over the top of the other each on independent X-axis stages. An 8 channel pipette travels on a Y-axis as does a Peltier device for controlling reaction temperatures and a magnet for bead collection/sample purification.

The system 60 and methods of the disclosure avoid prior art problems with the liquid handling robotics that were programmed to avoid reuse of pipette tip, capture beads, and reaction tubes. The system 60 can be operated without those constraints and any of those components may be re-used. Reusing those components simplifies the set-up and motion required in automation. The plates/cartridges are essentially self-contained. Those plates may be pre-loaded with tips and a receptacle for waste tips. Scientists and health professionals are taught in their laboratory courses to use a tip and throw it away, use a tube and throw it away. The system 60 is not limited by that paradigm. Systems and methods of the disclosure allow liquid aliquots to return to a tube after use, even never after a purification step. The systems and methods may operate in that fashion because pipette tips, materials, and reagents are “sample centric”. Those materials never go between samples. Reagent wells are only used once so any contamination going into them from a “dirty” tip will never transfer out in any way.

In preferred embodiments, each sample includes nucleic acid and performing the series of reaction produces a library of DNA fragments, wherein each fragment comprises a sequence corresponding to a portion of the nucleic acid and an adapter. The system is operable to transfer reagents within each replicate of the plurality of reagents using, for that replicate, one pipette of the multichannel pipette. Preferably, each replicate of the plurality of reagents is confined to one row of the multiwell plate. The system may be programmed to move the multichannel pipette to different columns of the multiwell plate while keeping individual pipette tips of the multichannel pipette within rows of the multiwell plate. The handling device may have one or more loading stage onto which a multiwell plate can be removably loaded. The multichannel pipette is disposed by handling device to access wells of the multiwell plate when the multiwell plate is loaded onto the loading stage. Preferably, the handling device is further operable to slide the multiwell plate to position predetermined columns of wells under the multichannel pipette, transfer, by means of the multichannel pipette, liquids among wells within rows of wells of the plate, and bring at least one column the multiwell plate into contact with a heating device to promote a reaction in wells of the at least one column.

In some embodiments, each replicate of the plurality of reagents has beads for capturing and isolating nucleic acid fragments, amplification enzymes, sequencing adaptors, and ligase. Each sample may include nucleic acid. The system may be used to produce a library of DNA fragments, in which each fragment comprises a sequence corresponding to a portion of the nucleic acid and an adapter. Other features and embodiments are within the scope of the disclosure.

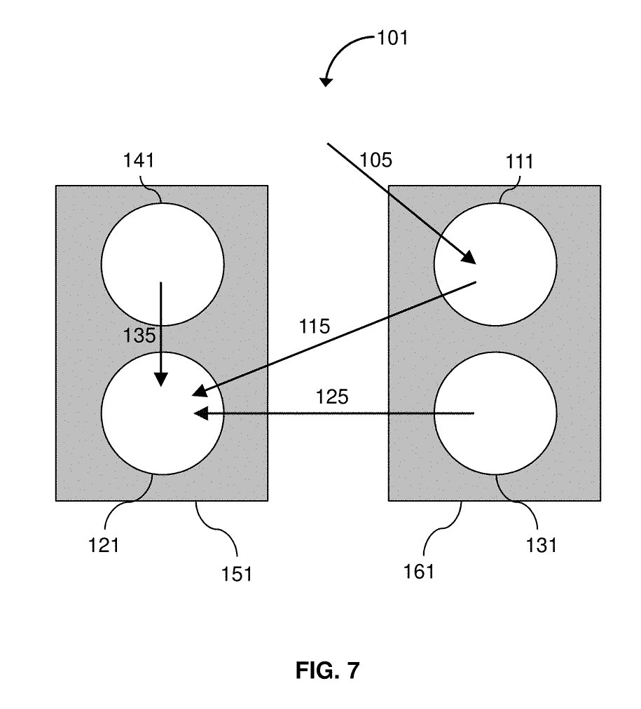

FIG. 7 is a schematic of a method 101 according to an embodiment of the invention. The method includes a sequence of transfers of material among four reservoirs. An elution buffer storage reservoir 111 contains a liquid that promotes release of a reagent from particles to which the reagent is reversibly bound. The reagent may be a nucleic acid, such as DNA or RNA, and the liquid may be an elution buffer. A reaction reservoir 121 may be empty, or it may contain an organic liquid that is immiscible with water and less dense than water, such as mineral oil. A reactant reservoir 131 contains a liquid that contains one or more reactants that promote a reaction when the contact the reagent. A particle storage reservoir 141 contains a liquid that contains particles that reversibly bind to the reagent. The reservoirs may be wells in disposable plates. Preferably, the particle storage reservoir 141 and the reaction reservoir 121 are contained within a reaction plate 151, and the elution buffer storage reservoir 111 and reactant reservoir 131 are contained within a storage plate 161.

In a first step, liquid containing particles bound to the reagent is transferred 105 to the elution buffer storage reservoir 111. Upon contact with the liquid in the elution buffer storage reservoir 111, the reagent is released from the particles. Liquid containing the free reagent is then transferred 115 to the reaction reservoir 121, while the particles remain in the elution buffer storage reservoir. Next, liquid containing one or more reactants is transferred 125 from the reactant reservoir 131 to the reaction reservoir 121. Upon contact with the reagent, the reactants react with the reagent. In the final step of the sequence, liquid containing particles is transferred 135 from the particle storage reservoir 141 to the reaction reservoir 121. The particles bind to the reagent upon contact.

Each of the transfer steps 105, 115, 125, and 135 is performed using a single transfer receptacle. The repeated use of a single transfer receptacle conserves resources and expedites processing by avoiding the need to change the transfer receptacle between transfer steps. However, the method may include a final transfer step in which the reaction product, such as a nucleic acid library, is transferred to a new reservoir using a new transfer receptacle. The use of a fresh transfer receptacle for the final transfer ensures the purity of the end product.

The transfer receptacle may be any receptacle suitable for transferring liquid. Many suitable transfer receptacles are known in the art. For example and without limitation, the transfer receptacle may be a pipette tip, pipette, tubing, vessel, tube, or the like.

The reservoirs may be any reservoir suitable for holding liquids. Many suitable reservoirs are known in the art. For example and without limitation, each reservoir may independently be a well, indentation, tube, vessel, chamber, pocket, or the like.

The reagent may be any component that can be subjected to molecular analysis. The reagent may be a biological macromolecule, such as a nucleic acid, protein, lipid, carbohydrate, or any combination thereof. Preferably, the reagent is a nucleic acid, such as DNA or RNA.

A reactant may be any agent that interacts with the reagent to permit a chemical reaction to occur. The reactant need not be a reactant in the formal chemical sense of a substance that undergoes a change during a chemical reaction. Thus, the reactant may be a substrate, enzyme, catalyst, or cofactor. The reactant may be an enzyme that modifies DNA or RNA. For example and without limitation, the reactant may be an endonuclease, exonuclease, gyrase, kinase, ligase, methyltransferase, nickase, phosphatase, polymerase, recombinase, sulfurylase, thermostable polymerase, or uracil-DNA glycosylase. The reactant may be a metal, such as calcium, copper, iron, magnesium, or manganese, molybdenum, nickel, or zinc. The reactant may be a nucleotide, including modified nucleotides and nucleotide analogs. The nucleotide may include 0, 1, 2, or 3 phosphate groups.

The particles may be any type of particle that reversibly a reagent of interest, such as a macromolecule. The particles may contain acrylate resin. agarose, alumina, anion-exchange carrier, apatite, boron carbide, carbon, cellulose, dextran, diatomaceous earth, epoxy resin, gelatin, glass, graphite, hydrogels, iron, metal, mica, nitrocellulose, phenol resin, polyamide, polycarbodiimide resin, polycarbonate, polyethylene fluoride, polyethylene glycol, polyimide, polymeric polyols, polypropylene, polyvinyl chloride, polyvinylidene fluoride, polyvinylpyrrolidone, quartz, silica, silicon carbide, silicon nitride, zirconia, or zeolite. The particles may be magnetic or paramagnetic. The particles may have a surface coating that facilitates binding to a reagent. Particles that reversibly bind nucleic acids are described in U.S. Pat. Nos. 5,693,785; 5,898,071; 8,658,360; and 8,426,126, the contents of each of which are incorporated herein by reference.

When the reagent is released from the particles, for example after transferring step 105, it may be useful to separate the particles from the reagent-containing solution. When magnetic or paramagnetic particles are used, separation can be achieved by applying a magnetic field to the mixture to retain the particles in the elution buffer storage reservoir 111 while transferring 115 only the soluble components of the mixture to the reaction reservoir 121. Methods of separating magnetic beads during processing of nucleic acids is known in the art and described in, for example, U.S. Pat. Nos. 5,898,071 and 8,426,126, the contents of each of which are incorporated herein by reference.

The liquid in the elution buffer storage reservoir may be any liquid that facilitates release of the reagent from particles. It may elute the reagent from the particles by, for example, changing the pH, salt concentration, or presence of chaotropic agents in solution. The liquid may sequester an agent that promotes binding of the reagent to the particles. Buffers used for elution of nucleic acids, such as DNA and RNA, and other macromolecules are known in the art. The liquid may be Tris-EDTA or water. Buffers for elution of nucleic acids are described in, for example, U.S. Pat. No. 9,206,468; US Pub. No. 2010/0173392; and Molecular Cloning, A Laboratory Manual, 4th Edition, Green and Sambrook eds., Cold Spring Harbor Laboratory PRESS, Cold Spring Harbor, N.Y. (2012), the contents of each of which are incorporated herein by reference.

The elution buffer storage reservoir 111 and reactant reservoir 131 are pre-loaded with the appropriate liquids prior to performing the sequence of transfer steps. Preferably, the elution buffer storage reservoir 111 and reactant reservoir 131 are pre-loaded with only the volume of liquid needed to perform a reaction. Precise loading of these reservoirs provides two advantages. First, it minimizes the amount of material needed to perform a reaction. Reactants, such as purified enzymes, may be expensive, and costs can escalate when multiple samples are processed in parallel and when, as discussed below, multiple reactions are performed sequentially on each sample. By loading only the amount of material needed for a reaction into each reservoir, waste is avoid, and costs are kept low. Another advantage of loading the proper amount of material into each reservoir is that it obviates the need to adjust setting on the transfer receptacle, such as an electronic pipette, in between transfer steps. Consequently, the transfers can be executed more quickly, and the process as a whole is more efficient.

The reaction reservoir may contain a liquid that prevents evaporation of the reaction mixture during the reaction. Generally, the reaction mixture is an aqueous solution, so the reaction reservoir should contain a liquid that is immiscible with water and less dense than water. The liquid may an organic liquid. For example and without limitation, the liquid may be an oil, an alkane, ketone, benzene, toluene, tetrahydrofuran, triethyl amine, or xylene. The oil may be mineral oil, corn oil, or vegetable oil.

Another advantage of using a low-density, water-immiscible liquid in the reaction reservoir is that it facilitates quantitative transfer of the aqueous contents of the reaction reservoir 121 to another location. For example, after transfer step 135, it will often be necessary to transfer the reaction mixture and particles to another reservoir. Moreover, it may undesirable to introduce air bubbles when doing so. By calibrating the transfer receptacle to transfer a volume that slightly exceeds the volume of aqueous contents in reaction, all of the aqueous contents will be transferred along with a small amount of the water-immiscible liquid, and no air will be introduced into the transfer receptacle. Thus, all of the reagent will be retained without causing foaming or other disturbances created by air bubbles.

Many chemical and biochemical reactions occur optimally at a particular temperature. For example, many enzymes display higher activity at a certain temperature or range of temperatures. Therefore, the method 101 may include heating or cooling the reaction reservoir 121 to facilitate the reactions occurring therein. The heating or cooling step may occur subsequent to or concurrently with transfer step 115 or transfer step 125. The heating or cooling step may include maintaining the reaction reservoir 121 at a defined temperature for a defined time period. Preferably, the temperature maintains the reaction mixture in a liquid form, e.g., a temperature between 0 degrees C. and 100 degrees C., inclusive. The time period may be any interval suitable for executing the reaction, for example an interval between 30 seconds and 1 hour, inclusive. The heating or cooling step may include returning the reaction reservoir 121 to its original temperature.

As indicated above, method 101 may include the use of magnetic particles that reversibly bind to the reagent and can be easily separated from solution-phase contents of a mixture, such as a reaction mixture. Therefore, the method 101 may include applying a magnetic field during a transfer step and/or between transfer steps. For example, a magnetic field may be applied between transfer steps 105 and 115 or during transfer step 115 to retain the magnetic particles in the elution buffer storage reservoir while the soluble contents are transferred to the reaction reservoir 131.

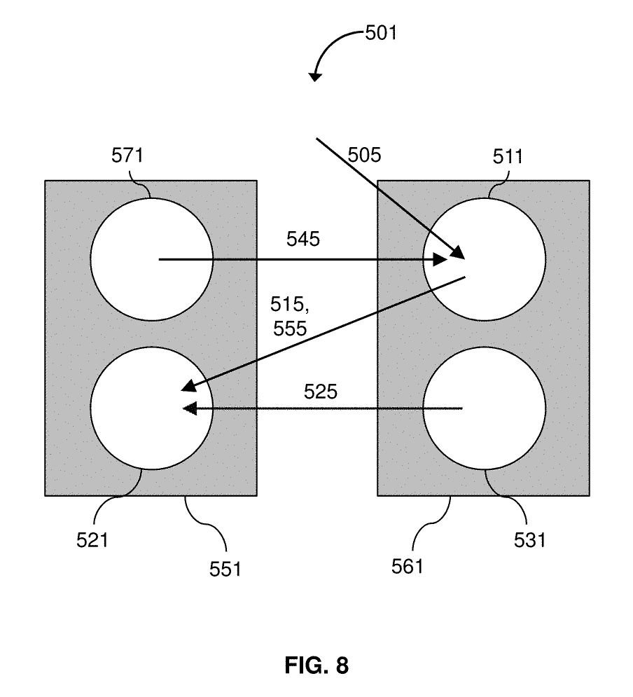

FIG. 8 is a schematic of a method 501 according to an embodiment of the invention. It differs from the method 101 described above in that the particles are reused. An elution buffer storage reservoir 511 contains a liquid that promotes release of a reagent from particles to which the reagent is reversibly bound. A reaction reservoir 521 may be empty, or it may contain an organic liquid that is immiscible with water and less dense than water, such as mineral oil. A reactant reservoir 531 contains a liquid that contains one or more reactants that promote a reaction when the contact the reagent. A particle binding buffer reservoir 571 contains a liquid that contains particles that promotes binding of particles to the reagent. The reservoirs may be wells in disposable plates. Preferably, the particle binding buffer reservoir 571 and the reaction reservoir 521 are contained within a reaction plate 551, and the elution buffer storage reservoir 511 and reactant reservoir 531 are contained within a storage plate 161.

In a first step, liquid containing particles bound to the reagent is transferred 505 to the elution buffer storage reservoir 511. Upon contact with the liquid in the elution buffer storage reservoir 511, the reagent is released from the particles. Liquid containing the free reagent is then transferred 515 to the reaction reservoir 521, while the particles remain in the elution buffer storage reservoir 511. Next, liquid containing one or more reactants is transferred 525 from the reactant reservoir 531 to the reaction reservoir 521. Upon contact with the reagent, the reactants react with the reagent. Particle binding buffer is then transferred 545 from the particle binding buffer reservoir 571 to the elution buffer storage reservoir 511, and the particles are re-suspended. Re-suspended particles are then transferred 555 from the elution buffer storage reservoir 511 the reaction reservoir 521, where the particles bind to the reagent upon contact.

The method may contain one or more transfer steps that allow the particles to be washed in a washing buffer prior to resuspension of the particles in particle binding buffer. Washing may entail the following transfer steps: transfer of wash buffer from a wash buffer storage reservoir to allow the particles to be re-suspended; and transfer of the liquid from the elution buffer storage reservoir, while the particle remain in the elution buffer storage buffer reservoir. The transfer steps involved in washing the particles may be repeated. The transfer steps involved in washing the particles are performed after transfer step 515 but prior to transfer step 545. The transfer steps involved in washing the particles may be performed after transfer step 525. The wash buffer storage reservoir may be contained within the reaction plate 551.

The sequences of steps in the methods described above are useful for performing a single reaction or multiple reactions simultaneously on the reagent. However, the invention also includes methods of performing multiple reactions sequentially on the reagent by executing multiple iterations of the sequence in a defined order. For example 2, 3, 4, 5, 6, 7, 8, 9, 10, or more reactions may be performed sequentially by executing the sequence of steps the appropriate number of times and using appropriate reactants for each iteration. Thus, the sequence of steps within each iteration allows a one or more concurrent reactions to occur, and the sequence of iterations allows multiple reactions to occur sequentially.

In methods that involve multiple iterations of the sequence of steps described above, each iteration uses a new elution buffer storage reservoir and new reactant reservoir. Each elution buffer storage reservoir (EBSR) and reactant reservoir (RR) can be designated to indicate the iteration of the sequence in which the reservoir is used. For example, the reservoirs used in the first iteration can be designated EBSR1 and RR1, those used in the second iteration can be designated EBSR2 and RR2, etc. The use of a unique elution buffer storage reservoir and reactant reservoir for each iteration ensures that the reactions occur in the proper sequence. Typically, the reactions performed and the reactants used will be different for each iteration, or at least for consecutive iterations. Therefore, the contents of RR1, RR2, etc. will differ as well. The composition of the elution buffers in EBSR1, EBSR2, etc. may be the same or different. Even if the same elution buffer is used for multiple consecutive iterations, however, the use of a fresh aliquot for each iteration ensures that residual reagent from one reaction will not contaminate a subsequent reaction.

In methods that involve multiple iterations of the sequence of steps described above, each iteration uses the same reaction reservoir. Multiple iterations may use the same particle storage reservoir or different particle storage reservoirs. The repeated use of the reaction reservoir and particle storage reservoir conserves resources and simplifies the logistics of the methods.

When methods involving multiple iterations of the sequence of transfer steps are performed, the transfer steps are the same with two exceptions. First, in the first iteration, transfer step 105 occurs from an external source that contains particle-bound reagent. In the second and subsequent iterations, however, the source of particle-bound reagent is the reaction reservoir 121. The second difference is that new elution buffer storage reservoir and reactant reservoir are used for each iteration, as discussed above.

Given that methods involving multiple iterations of the sequence of transfer steps described above require a unique elution buffer storage reservoir and reactant reservoir for each iteration, a convenient format for such methods is to have the elution buffer storage reservoirs and reactant reservoirs arrayed sequentially on a multiwell plate.

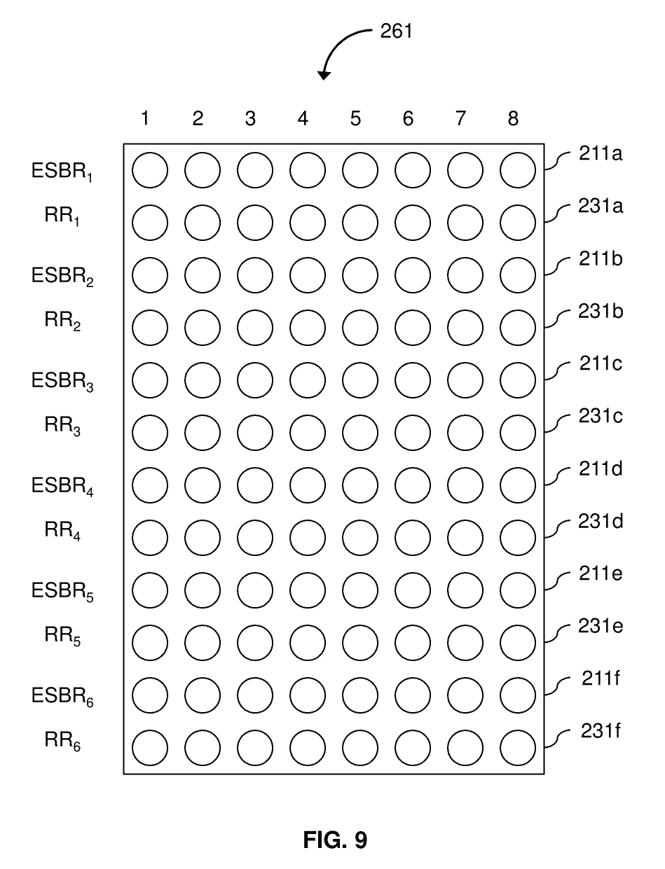

FIG. 9 is a schematic of a storage plate 261 according to an embodiment of the invention. As illustrated in a non-limiting example, the storage plate 261 has six pairs of rows, with each pair consisting of one row 211a-f of elution buffer storage reservoirs and one row 231a-f of reactant reservoirs. Each pair of rows contains reservoirs for one iteration of the sequence of transfers, so the storage plate 261 can be used for six iterations of the sequence. The storage plate 261 has eight columns, each column containing reservoirs for processing of a different sample. Thus, the storage plate 261 contains materials for performing six sequential reactions on eight different samples.

The storage plate 261 in the illustration is provided as an example. However, other structures and configurations are possible within the scope of the invention. Any structure capable of holding liquids can be used. In addition, configurations that allow processing of different numbers of samples or different numbers of reactions may be used.

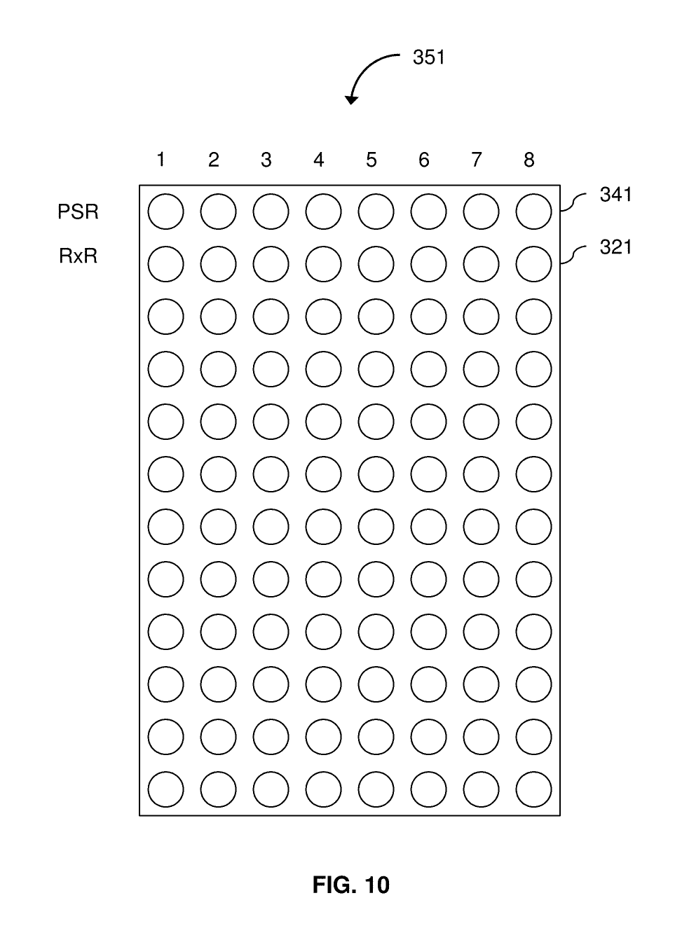

FIG. 10 is a schematic of a reaction plate 351 according to an embodiment of the invention. The reaction plate 351 has a row 341 of particle storage reservoirs and a row 321 of reaction reservoirs. As illustrated in a non-limiting example, the reaction plate 351 has eight columns, each column containing reservoirs for processing of a different sample. Thus, the reaction plate 351 has reservoirs for performing sequential reactions on eight different samples.

The storage plate 351 in the illustration is provided as an example. However, other structures and configurations are possible within the scope of the invention. Any structure capable of holding liquids can be used. In addition, configurations that allow processing of different numbers of samples or different numbers of reactions may be used.

The reaction plate 351 may have rows of other types of reservoirs that are useful for performing the methods of the invention. For example and without limitation, the reaction plate 351 may have reservoirs that contain identifying adaptors, such as barcoded adaptors, liquids that promoting binding between particles and the reagent, and liquids for washing or rinsing particles. The reaction plate may have reservoirs for holding the input sample prior to commencing the transfer steps. The reservoirs for holding the input sample may be pre-loaded with particles to allow binding of the reagent in the input sample to the particles prior to commencing the transfer steps. The reaction plate 351 may also have empty reservoirs for holding the finished reagent after the sequence of reactions has been performed or for storing waste generated during processing. Additionally, the reaction plate 351 may contain transfer receptacles, such as pipette tips. As indicated above, the series of reactions are performed using a single transfer receptacle for each sample, and a second transfer receptacle may be used to transfer the final reaction product to a holding reservoir. Thus, the reaction plate 351 may hold two transfer receptacles per sample. Preferably, the transfer receptacles are arranged in row parallel to the rows of particle storage reservoirs and reaction reservoirs, with one transfer receptacle aligned with a column corresponding to each sample. After the transfer receptacles have been used, they may be discarded into the waste reservoirs in the reaction plate 351.

The storage plate 261 and the reaction plate 351 can have a variety of configurations of reservoirs. The 96-well configuration shown in the figures is a convenient format, but it is an example provided only for illustrative purposes. Another convenient format is a 384-well plate having a 24×16 arrangement. Other configurations are possible within the scope of the invention. Preferably, the length and width of the storage plate 261 and of the reaction plate 351 are the same. It is also preferable that the storage plate 261 and of the reaction plate 351 have dimensions compatible with commercially available robotic liquid handlers.

The sequence of transfer steps outlined above can be implemented by transferring materials among the appropriate reservoirs in the storage plate 261 and reaction plate 351. Transfers may be performed by a robotic liquid handler having a linear multichannel pipette having a transfer receptacle for each channel. As indicated above, the transfer receptacle may be a pipette, pipette tip, tubing, or other receptacle suitable for liquid transfer. Although liquids and particles are transferred between reservoirs within a plate and between reservoirs in different plates, no material is transferred between reservoirs in different columns. Because each column contains material from a single sample, there is no need to change the transfer receptacle to avoid cross-contamination between samples. Consequently, an entire sequence of reactions can be performed by using a single transfer receptacle for each sample.

Layouts of the storage plate 261 and reaction plate 351 in which the reservoirs for each sample are collinear are advantageous for setting up systems for implementing methods of the invention.

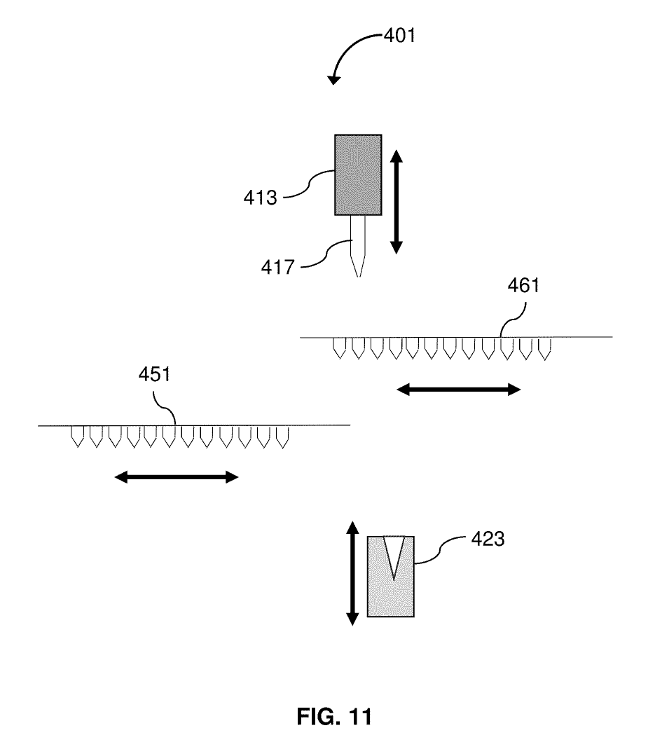

FIG. 11 is a schematic of a system 401 according to an embodiment of the invention. The system 401 includes a storage plate 461 and a reaction plate 451. Each of the storage plate 461 and the reaction plate 451 has multiple reservoirs for one or more samples, with all the reservoirs for a each sample being collinear in a column, as described above. The columns of the storage plate 461 are parallel to the columns on the reaction plate 451. Each of the storage plate 461 and the reaction plate 451 is slidable along an axis parallel to the columns. In addition, the storage plate 461 and the reaction plate 451 may be vertically displaced relative to each other. For example, the storage plate 461 may be higher than the reaction plate 451, or vice versa.

The system 401 also includes a transfer device 413 with one or more transfer receptacles 417. The transfer device 413 is positioned above the storage plate 461 and a reaction plate 451 and can be translated vertically. At a low point in its translation, the transfer device 413 allows the transfer receptacle 417 to withdraw liquid from a reservoir in the storage plate 461 or the reaction plate 451 or to expel liquid into such a reservoir. At a high point in its translation, the transfer device 413 allows the storage plate 461 and the reaction plate 451 to slide along their axes unobstructed by the transfer receptacle 417.

The system 401 may include a temperature control device 423, such as a Peltier device. The temperature control device 423 is positioned below the storage plate 461 and a reaction plate 451 and can be translated vertically. At a high point in its translation, the temperature control device 423 contacts the one or more reaction reservoirs in the reaction plate 451. When in contact with the reaction reservoirs, the temperature control device 423 regulates the temperature of those reservoirs to promote the reactions occurring therein. For example, it may heat the reaction reservoirs to increase the activity of an enzyme in the reaction mixtures. The temperature control device 423 may also be able to contact one or more reservoirs in the storage plate 461 at a high point in its translation. At a low point in its translation, the temperature control device 423 allows the storage plate 461 and the reaction plate 451 to slide along their axes unobstructed.

As indicated above, methods of the invention may use magnetic particles that reversibly bind to the reagent. An advantage of magnetic particles is that they can be easily separated from solution-phase contents of a mixture, such as a reaction mixture. Therefore, the system 401 may include a magnetic device that applies a magnetic field to one or more reservoirs. Magnetic devices for separating magnetic particles from solutions contained in reservoirs are known in the art and described in, for example, U.S. Pat. Nos. 6,884,357 and 6,514,415 and in US Publication No. 2002/0008053, the contents of which are incorporated herein by reference. The magnetic device is positioned below the storage plate 461 and a reaction plate 451 and can be translated vertically. At a high point in its translation, the magnetic device contacts the one or more reaction reservoirs in the reaction plate 451 or storage plate 461. At a low point in its translation, the magnetic device allows the storage plate 461 and the reaction plate 451 to slide along their axes unobstructed. In a preferred embodiment, the magnetic device is integrated with the temperature control device 423.

One or more transfer receptacles 417, such as pipette tips, may be provided in the reaction plate 451, as described above. To facilitate transfer attachment of the transfer receptacles 417 to the transfer device 413, the system 401 may include a vertically translatable hammer mechanism that applies pressure to the transfer device.

Embodiments provide a method of performing a reaction, in which the method includes transferring a first plurality of particles bound to a reagent to a first reservoir comprising a first liquid using a transfer receptacle, thereby allowing the reagent to be released from the particles of the first plurality; transferring the reagent from the first reservoir to a second reservoir using the transfer receptacle, the transfer leaving substantially all of the particles of the first plurality in the first reservoir; transferring a second liquid comprising a reactant from a third reservoir to the second reservoir using the transfer receptacle, thereby allowing the reagent and the reactant to react; and transferring a second plurality of particles from a fourth reservoir to the second reservoir using the transfer receptacle, thereby allowing the reagent to bind to the particles of the second plurality, wherein the transferring steps are performed in sequence. Preferably the transfer receptacle is not replaced or washed between transferring steps. The transfer receptacle may be a pipette or pipette tip. The second reservoir may include an organic liquid that is immiscible with water and has a lower density than water. The reagent may be a nucleic acid. Optionally, the first liquid promotes release of the reagent from the particles of the first plurality. The method may include applying a magnetic field to the first reservoir while transferring the reagent from the first reservoir to the second reservoir. The method may include heating the second reservoir following the step of transferring the second liquid to the second reservoir. Optionally, the first reservoir and the third reservoir are disposed within a first structure, and wherein the second reservoir and the fourth reservoir are disposed within a second structure. The method may further include the following steps: transferring the reagent-bound particles of the second plurality from the second reservoir to a fifth reservoir comprising a third liquid, thereby allowing the reagent to be released from the particles of the second plurality; transferring the reagent from the fifth reservoir to the second reservoir using the transfer receptacle, the transfer leaving substantially all of the particles of the second plurality in the fifth reservoir; transferring a fourth liquid comprising a second reactant from a sixth reservoir to the second reservoir using the transfer receptacle, thereby allowing the reagent and the second reactant to react; and transferring a third plurality of particles from the fourth reservoir to the second reservoir using the transfer receptacle, thereby allowing the reagent to bind to the particles of the third plurality, wherein the transferring steps are performed in sequence, the transfer of the reagent-bound particles of the second plurality from the second reservoir to the fifth reservoir being performed after the transfer of the second plurality of particles from the fourth reservoir to the second reservoir.

Embodiments provide a method of performing a reaction, the method comprising: (a) transferring particles bound to a reagent to a first reservoir comprising a first liquid using a transfer receptacle (such as a pipette or pipette tip), thereby allowing the reagent to be released from the particles; (b) transferring the reagent from the first reservoir to a second reservoir using the transfer receptacle, the transfer leaving substantially all of the particles in the first reservoir; (c) transferring a second liquid comprising a reactant from a third reservoir to the second reservoir using the transfer receptacle, thereby allowing the reagent and the reactant to react; (d) transferring a third liquid from a fourth reservoir to the first reservoir, thereby re-suspending the particles in the third liquid; and (e) transferring the particles from the first reservoir to the second reservoir, thereby allowing the reagent to bind to the particles, wherein the steps are performed in sequence a, b, c, d, e, or a, b, d, c, e. Preferably, the transfer receptacle is not replaced or washed between transferring steps. The second reservoir may include an organic liquid that is immiscible with water and has a lower density than water. Preferably, the reagent is a nucleic acid. Optionally, the first liquid promotes release of the reagent from the particles. The method may further include applying a magnetic field to the first reservoir while transferring the reagent from the first reservoir to the second reservoir. The method may further include heating the second reservoir following the step of transferring the second liquid to the second reservoir. The first reservoir and the third reservoir may be disposed within a first structure, and wherein the second reservoir and the fourth reservoir are disposed within a second structure. The method may further include transferring the reagent-bound particles from the second reservoir to a fifth reservoir comprising a fourth liquid, thereby allowing the reagent to be released from the particles; transferring the reagent from the fifth reservoir to the second reservoir using the transfer receptacle, the transfer leaving substantially all of the particles in the fifth reservoir; transferring a fifth liquid comprising a second reactant from a sixth reservoir to the second reservoir using the transfer receptacle, thereby allowing the reagent and the second reactant to react; transferring the third liquid from the fourth reservoir to the fifth reservoir, thereby re-suspending the particles; and transferring the particles from the fifth reservoir to the second reservoir, thereby allowing the reagent to bind to the particles, wherein the transferring steps are performed in sequence, with the caveats that: transfer of the third liquid from the fourth reservoir to the fifth reservoir may be performed prior to transfer of the reagent from the second liquid from the sixth reservoir to the second reservoir, and transfer of the reagent-bound particles from the second reservoir to the fifth reservoir is performed after transfer of the particles from the first reservoir to the second reservoir.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of processing samples, the method comprising:
providing a plurality of samples;
providing a pipette and a plurality of reagents for each sample; and
performing a series of transfers to each sample using the pipette and reagents for that sample, without changing a pipette tip.

2. The method of claim 1, wherein each pipette has a pipette tip and the method includes using the pipette and the pipette tip for the series of transfers for each sample.

3. The method of claim 1, wherein each sample includes nucleic acid.

4. The method of claim 3, wherein the series of transfers provides a library of DNA fragments that contain sequences corresponding to portions of the nucleic acid.

5. The method of claim 1, wherein the series of transfers are performed simultaneously and in parallel for each of the plurality of samples.

6. The method of claim 1, wherein the plurality of reagents for each sample are provided in a row of wells along a multiwell plate.

7. The method of claim 6, wherein the pipette for each sample is provided as one member of a multichannel pipette.

8. The method of claim 7, wherein the performing step further includes loading the multiwell plate and the multichannel into a handling device, wherein the handling device operates to
slide the multiwell plate to position predetermined columns of wells under the multichannel pipette,
transfer, by means of the multichannel pipette, liquids among wells within rows of wells of the plate, and
bring at least one column the multiwell plate into contact with a heating device to promote a reaction in wells of the at least one column.

9. The method of claim 8, wherein each sample includes nucleic acid and performing the series of transfers results in a series of reactions that produces a library of DNA fragments, wherein each fragment comprises a sequence corresponding to a portion of the nucleic acid and an adapter.

10. The method of claim 1, wherein the plurality of reagents for each sample are provided in a row of wells along a multiwell plate, wherein the pipette for each sample is provided as one member of a multichannel pipette, and wherein the series of transfers are performed simultaneously and in parallel for each of the plurality of samples and the series of transfers includes translating the multichannel pipette over the multiwell plate.

11. A sample processing system comprising:
a multichannel pipette;
a plurality of reagent wells; and
a plurality of reagents replicated in subsets of the plurality of reagent wells.

12. The system of claim 11, wherein the plurality of reagent wells are provided as at least one multiwell plate.

13. The system of claim 12, wherein the system is operable to transfer reagents within each replicate of the plurality of reagents using, for that replicate, one pipette of the multichannel pipette.

14. The system of claim 13, wherein each replicate of the plurality of reagents is confined to one row of the multiwell plate.

15. The system of claim 14, wherein the system is programmed to move the multichannel pipette to different columns of the multiwell plate while keeping individual pipette tips of the multichannel pipette within rows of the multiwell plate.

16. The system of claim 15, further comprising a handling device comprising at least one loading stage onto which the multiwell plate can be removably loaded, wherein the multichannel pipette is disposed by handling device to access wells of the multiwell plate when the multiwell plate is loaded onto the loading stage.

17. The system of claim 16, wherein the handling device is further operable to
slide the multiwell plate to position predetermined columns of wells under the multichannel pipette,
transfer, by means of the multichannel pipette, liquids among wells within rows of wells of the plate, and
bring at least one column the multiwell plate into contact with a heating device to promote a reaction in wells of the at least one column.

18. The system of claim 11 wherein each replicate of the plurality of reagents comprises: beads for capturing and isolating nucleic acid fragments; amplification enzymes; sequencing adaptors; and ligase.

19. The system of claim 18, wherein the plurality of reagent wells are provided as at least one multiwell plate and the system further comprises a plurality of sample distributed across a column of wells.

20. The system of claim 19, wherein each sample includes nucleic acid and the system is operable to produce a library of DNA fragments, wherein each fragment comprises a sequence corresponding to a portion of the nucleic acid and an adapter.
